(19) United States
(12) Patent Application Publication
(10) Pub. No.: US 2003/0170011 A1
(43) Pub. Date: Sep. 11, 2003

(54) System and method for seamless navigation between local and external documents in an optical disc player

(76) Inventors: Masato Otsuka, Torrance, CA (US); Ramaswamy Devarajan, Long Beach, CA (US); Sanjay Kulkarni, Torrance, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/971,447

(22) Filed: Oct. 5, 2001

Related U.S. Application Data
(60) Provisional application No. 60/324,612, filed on Sep. 24, 2001.

(51) Int. Cl. H04N 5/85; H04N 5/781

(52) U.S. Cl. 386/125; 386/126

(57) ABSTRACT

A system and method of navigating between local and external user agent documents in an optical disc player. The method entails displaying a local document from a local optical disc, transmitting a request for an external document with a pointer to the local document to an external source, and displaying the external document having a navigation button associated with the local document pointer. Also, a system and method of synchronizing video and user agent documents in an optical disc player. Also, a system and method to change the navigation of user agent contents dynamically. The method entails displaying a first user agent document and playing a video segment within the first document, receiving a request for a second document while the playback of the video segment is at a particular playback location, displaying the second user agent document, receiving another request for the first document, and re-displaying the first document with the playback of the video segment starting at the particular playback location.

### CROSS REFERENCE TO A RELATED APPLICATION

This application claims the benefit of the filing date of Provisional Patent Application No. ______, filed on Sep. 24, 2001, and entitled “System and Method for Seamless Navigation Between Local and External Documents in an Optical Disc Player,” which is incorporated by reference.

### FIELD OF THE INVENTION

This invention relates generally to optical disc players, such as digital versatile disc (DVD) players and other formats, that have user-agent program playback capability that can access user agent data (e.g. HTML documents and objects) from a local optical disc or an external source (e.g. a server located on the Internet or Intranet, an external hard drive, an external optical disc drive, and other sources). In particular, the invention describes a system and method for seamless navigation between local and external user agent documents, and in a manner that the local and external user agent documents are synchronous with the corresponding video being displayed with these documents. This invention also relates to changing the navigation between local and external user agent documents dynamically for providing a more lively experience to the users.

### BACKGROUND OF THE INVENTION

The invention relates to optical disc players that can play user agent data and video data concurrently. The optical disc player executes a user agent program which can access user agent documents (e.g. HTML documents containing text, images, such as JPEG and GIF images, animated content, etc.) from external sources (e.g. a server across the Internet or Intranet, and external hard drive, or an external optical disc drive, etc.) and from the local optical disc.

A content developer can author an interaction application stored on a local optical disc for execution by an optical disc player that interacts video content stored on the local optical disc and user agent documents also stored on the local optical disc. For example, a content developer may author an optical disc containing a video movie as well as user agent documents containing information about the movie. In user agent mode, the user agent program residing on the optical disc player loads one of the user agent documents associated with chapter one of the movie and loads chapter one of the video movie in a sub-window of the corresponding user agent document. When the video movie chapter changes to chapter two, another user agent document is loaded that is synchronized with chapter two.

A disadvantage of the above system is that the navigation between user agent documents on the disc remains static once the disc is shipped. That is, once a content developer has authored the optical disc with a user agent document navigation structure, the navigation between user agent documents on the disc remains the same. User experience for such a disc goes dull with time and over a period of time the user gets bored of watching the same disc over and over again. This reduces the overall long-term value of such discs. Thus, there is a need for a mechanism to provide a lively dynamic navigation behavior of user agent documents.

Another disadvantage of local user agent documents being static is that information in the local user agent documents may get obsolete over time, and sometimes there is a need to update the information. Thus, there is a need for a system and method to access and load updated user agent documents from one or more external sources, such as servers located across a network (e.g. such as the Internet or Intranet) or another storage medium such as an external hard drive or external local drive.

Not only is there a need to access updated user agent documents from external sources, there is a further need to make the navigation between local user agent documents and external user agent documents seamless, i.e. the displaying of local user agent documents and external user agent documents is transparent to the user. In this way, a user need not be concerned with whether the user agent document being displayed comes from the local optical disc or an external source. In addition to the need for seamless navigation between local and external user agent documents, there is a further need for providing synchronization with video content and user agent documents, taking into account that some of the user agent documents come from the local optical disc and others come from one or more external sources.

Such needs and others are met with the system and method seamless navigation between local and external user agent documents in accordance with the invention.

### SUMMARY OF THE INVENTION

An aspect of the invention relates to a method of navigating between local and external user agent documents in an optical disc player. The method comprises accessing and displaying a local user agent document from a local optical disc inserted into the optical disc player, receiving and transmitting a request for an external user agent document along with a pointer to the local user agent document to an external source, and receiving and displaying the external user agent document having a “BACK” navigation button associated with the pointer to the local user agent document. A user can push the “BACK” navigation button causing the accessing and displaying of the previously displayed local user agent document. Optionally, the external user agent document can override the pointer to point to another user agent document residing either on local optical disc or external/server, thereby entirely changing the navigation behavior of the disc. Using pointers can allow navigation between local and external user agent documents to be made dynamic and seamless, i.e. transparent to the user.

Another aspect of the invention relates to an optical disc player that implements the above navigation methodology. The optical disc player comprises an optical disc reader to read a local user agent document from a local optical disc, an interface to an external source for an external user agent document, and a processor to cause an access and display of the local user agent document, to cause the transmission of a request for the external user agent document along with a pointer to the local user agent document to the external source, and to receive and cause the display of the external user agent document with a “BACK” navigation button associated with the pointer to the local user agent document. A user using an input device can select the “BACK” navigation button to cause the display of the local user agent document. Using pointers can allow navigation between local and external user agent documents to be made seamless, i.e. transparent to the user

Yet another aspect of the invention relates to a method of synchronizing video and user agent documents in an optical disc player. The method comprises accessing and displaying a first user agent document and playing back a video segment within the first user agent document, receiving a first request for a second user agent document while the playback of the video segment is at a particular playback location, accessing and displaying the second user agent document, receiving a second request for the first user agent document, and re-accessing and re-displaying the first user agent document with the playback of the video segment beginning at the particular playback location. In this way, when a user navigates to a second user agent document from a first user agent document while a video segment is being displayed, the user can then navigate back to the first user agent document and the video segment continues from where the user last viewed it, instead of the beginning.

Still another aspect of the invention relates to an optical disc player that implements the above synchronization method. The optical disc player comprises a processor to cause a display of a first user agent document and a playing of a video segment within the first user agent document, to cause a display of a second user agent upon receiving a first request for the second user agent document while the playback of the video segment is at a particular playback location, and to cause a redisplay of the first user agent document and a playing back of the video segment starting at approximately the playback location when the first request was received. In this way, when a user navigates to a second user agent document from a first user agent document while a video segment is being displayed, the user can then navigate back to the first user agent document and the video segment continues from where the user last viewed it, instead of the beginning.

Other aspects, features and techniques of the invention will become apparent to one skilled in the relevant art in view of the following detailed description of the invention.

### BRIEF DESCRIPTION OF THE DRAWINGS

FIG. 1 illustrates a hardware block diagram of an exemplary optical disc player in accordance with the invention;

FIG. 2 illustrates a program module block diagram of an exemplary optical disc player in accordance with the invention;

FIG. 3 illustrates a display screen of an exemplary user agent document in user agent mode in accordance with the invention;

FIG. 4A illustrates a flow diagram of an exemplary method of providing seamless navigating between local and external user agent documents in accordance with the invention;

FIG. 4B illustrates a flow diagram of an exemplary method of providing dynamically changed navigation between local and external user agent documents in accordance with the invention;

FIG. 5 illustrates a flow diagram of a navigation method which causes a de-synchronization of the video segment to the corresponding user agent document; and

FIG. 6 illustrates a flow diagram of a navigation method that improves the synchronization of the video segment to the corresponding user agent document in accordance with the invention.

### DETAILED DESCRIPTION OF THE INVENTION

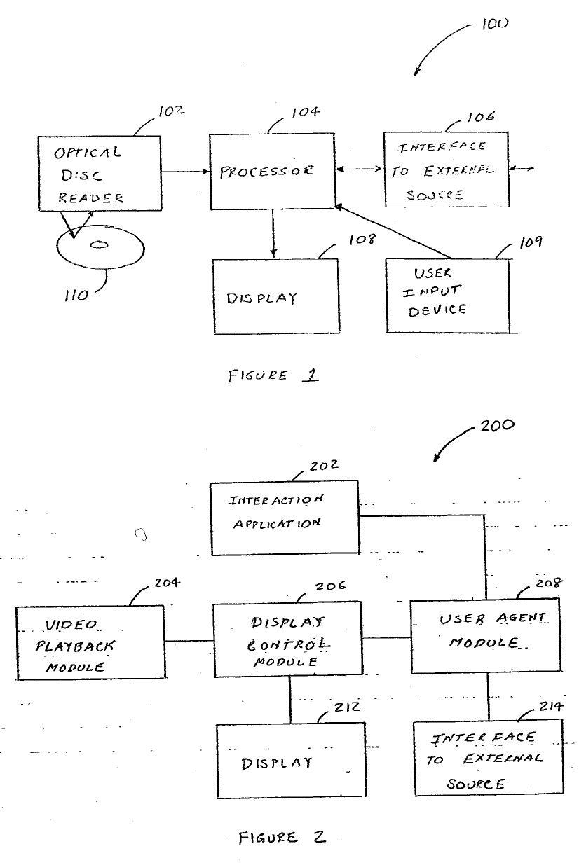

FIG. 1 illustrates a hardware block diagram of an exemplary optical disc player 100 in accordance with the invention. The optical disc player 100 comprises an optical disc reader 102, a processor 104, an interface to external sources 106, optionally a display 108, and a user input device 109. The optical disc player 100 may be embodied as a dedicated optical disc player or may be embodied as a program running on a computer. The processor 108 executes one or more program modules which controls the accessing of video data and user agent documents from a local optical disc 110 and one or more external sources (a server on the Internet or intranet, an external hard drive, an external optical disc drive, etc.) respectively by way of the optical disc reader 102 and the external source interface 106. The processor 108 under the control of one or more program modules can also causes the display of user agent documents containing video on the display 108. The user input device 109 (e.g. keyboard, mouse, remote control, etc.) allows a user to navigate between different user agent documents.

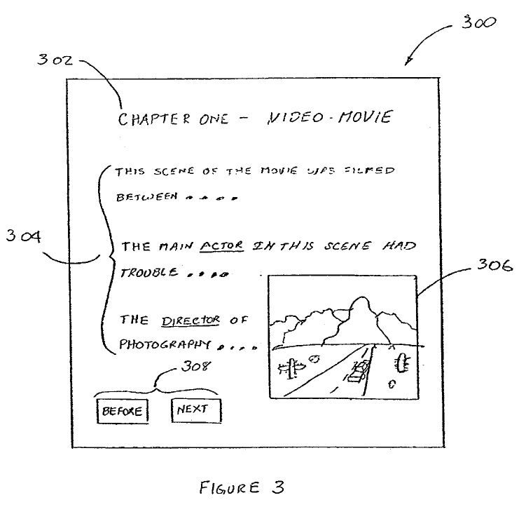

FIG. 2 illustrates a program module block diagram of an exemplary optical disc player 200 in accordance with the invention. The optical disc player 200 comprises an interaction application 202, a video playback module 204, a display control module 206, a user agent module 208, an optional display 212, and an interface 214 to an external source. The interaction application 202 (e.g. a Java script), which is generally authored by a content developer, controls the desired interaction between video content and the user agent documents. The user agent module 208 (e.g. a browser program) controls the access of user agent documents from a local optical disc and an external source. The video playback module 204 (e.g. a DVD playback subsystem) controls the streaming of video data from the local optical disc or from an external source. The display control module 206 (e.g. Plug-In or Active-X) controls the simultaneous display of user agent documents from the user agent module 208 and corresponding video segments from the video playback module 204. The interface 214 (e.g. an TCP/IP, HTTP, and/or USB interface) facilitates the accessing of user agent data and/or video data from one or more external sources (a server on the Internet or intranet, an external hard drive, an external optical disc drive, etc.).

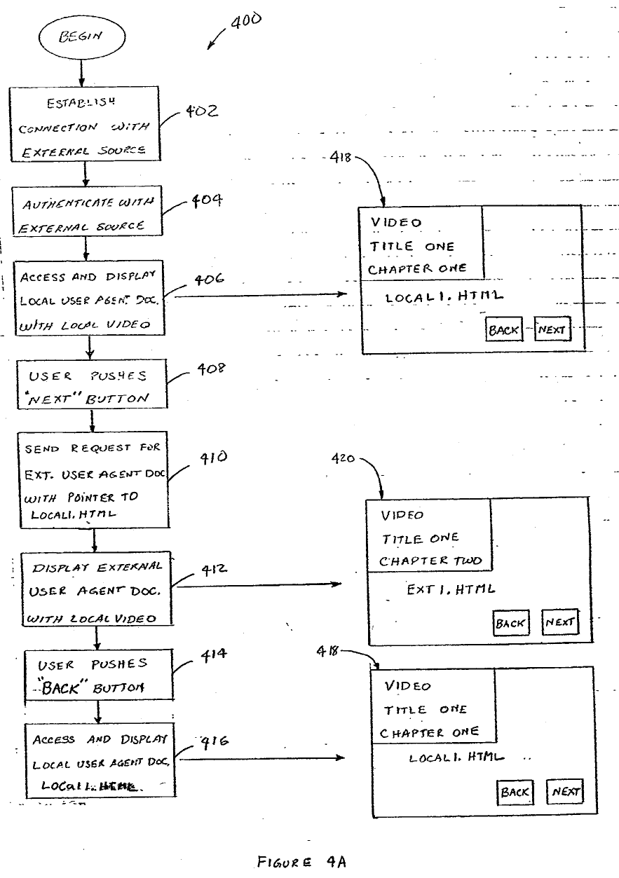

FIG. 3 illustrates a display screen of an exemplary user agent document 300 in user agent mode in accordance with the invention. The user agent document 300 may comprise a title section 302, an information section 304 providing information about the video segment being displayed, a video sub-window 306 for displaying the video segment, and navigation buttons 308 for navigating between different user agent documents and/or video segments. The navigation buttons 308 can be customized by a content provider authoring the interaction application 202.

As previously discussed, some of the user agent documents may be accessed from the local optical disc 110, which are termed herein as “local user agent documents.” Other user agent documents may come from external sources, such as servers located across a network (e.g. such as the Internet or Intranet) or another storage medium such as an external hard drive or external local drive, by way of the interface 106 (214). These documents are referred to as “external user agent documents.” The reason for this may be that some of the local user agent documents have become obsolete, and thus updated documents are required from external sources. It is preferred, however, that the access and display of local and external user agent documents is made seamless, i.e. transparent to the user.

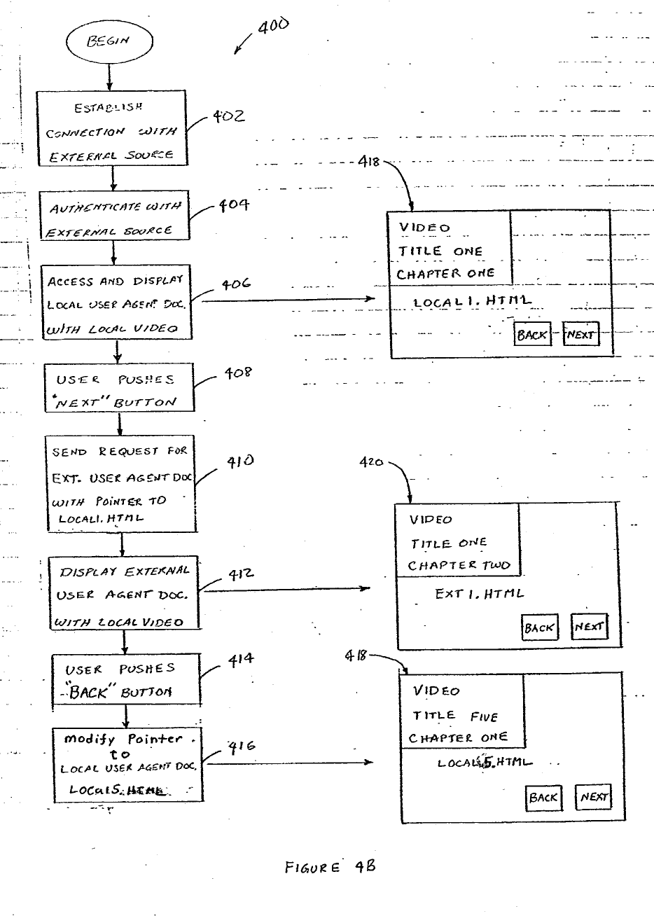

FIG. 4A illustrates a flow diagram of an exemplary method 400 of providing seamless navigating between local and external user agent documents in accordance with the invention. In step 402, the optical disc player 100 (200) establishes connection with the external source by way of the interface 106 (214). The connection can be established by standard protocols, such as TCP/IP, HTTP, USB or with other protocols. Once a connection is made to the external source, in step 404 the external source may require some kind of authentication before it can transmit data to the optical disc player 100 (200). The authentication may be of many forms, such as authentication by a unique identification number and/or password associated with the optical disc player 100 (200) and/or the user, and/or by a unique identification number associated with the application on the local optical disc 110, and/or by a content-scrambling system (CSS) encryption information residing on the local optical disc 110, and/or by a burst coded area (BCA) number associated with the application on the local optical disc 110, and/or by a user or group profile.

In step 406, the processor 104 under the control of the interaction application 202, user agent module 208, video playback module 204, and display control module 206, causes the access and display of a local user agent document Local1.HTML 418 including a video segment identified as title one—chapter one, and customized “BACK” and “NEXT” navigation buttons. In step 408, the user pushes the “NEXT” navigation button in user agent document Local1.HTML 418. In this case, the next user agent document Ext1.HTML 420 resides at an external source. In such a case, in step 410 the processor 104 under the control of the user agent module 208 causes the transmission of a request for the external user agent document Ext1.HTML 420 along with a pointer to the local user agent document Local1.HTML 418. At the external source, the pointer to the local user agent document Local1.HTML is assigned to the “BACK” navigation button of the external user agent document Ext1.HTML 420.

In step 412, the processor 104, under the control of the interaction application 202, user agent module 208, video playback module 204, and display control module 206, receives and causes the display of the external user agent document Ext1.HTML with another video segment identified as title one—chapter two being displayed in a sub-window, and “BACK” and “NEXT” navigation buttons. In step 414, the user pushes the “BACK” navigation button of the external user agent document Ext1.HTML 420. Since the pointer to local user agent document Local1.HTML has been assigned to the “BACK” navigation button, in step 416 the processor 104, under the control of the interaction application 202, user agent module 208, video playback module 204, and display control module 206, accesses and causes the display of local user agent document Local1.HTML.

Thus, by transmitting a pointer identifying a path to the previous local user agent document and assigning the pointer to a navigation button of the external user agent document, navigation between the local and the external user agent documents can be made seamless, i.e. transparent to the user. The above method can be used to access multiple user agent documents from multiple servers across the Internet or an Intranet or other external sources. Another advantage is that less cache memory is required to store pointers to previously accessed documents than to keep all previously retrieved document pointers in a cache memory.

FIG. 4B illustrates a flow diagram of an exemplary method 4001 of dynamically changing the navigation behavior between local and external user agent documents in accordance with the invention In step 4021, the optical disc player 100 (200) establishes connection with the external source by way of the interface 106 (214). The connection can be established by standard protocols, such as TCP/IP, HTTP, USB or with other protocols. Once a connection is made to the external source, in step 4041 the external source may require some kind of authentication before it can transmit data to the optical disc player 100 (200). The authentication may be of many forms, such as authentication by a unique identification number and/or password associated with the optical disc player 100 (200) and/or the user, and/or by a unique identification number associated with the application on the local optical disc 110, and/or by a content-scrambling system (CSS) encryption information residing on the local optical disc 110, and/or by a burst coded area (BCA) number associated with the application on the local optical disc 110, and/or by a user or group profile.

In step 4061, the processor 104 under the control of the interaction application 202, user agent module 208, video playback module 204, and display control module 206, causes the access and display of a local user agent document Local1.HTML 4181 including a video segment identified as title one—chapter one, and customized “BACK” and “NEXT” navigation buttons. In step 4081, the user pushes the “NEXT” navigation button in user agent document Local1.HTML 4181. In this case, the next user agent document Ext1.HTML 4201 resides at an external source. In such a case, in step 4101 the processor 104 under the control of the user agent module 208 causes the transmission of a request for the external user agent document Ext1.HTML 4201 along with a pointer to the local user agent document Local1.HTML 4181. At the external source, the pointer to the local user agent document Local1.HTML is assigned to the “BACK” navigation button of the external user agent document Ext1.HTML 4201. Optionally, this pointer can be modified to point to some other user agent document (Local5.HTML 4181) to change the navigation of the disc content.

In step 4121, the processor 104, under the control of the interaction application 202, user agent module 208, video playback module 204, and display control module 206, receives and causes the display of the external user agent document Ext1.HTML with another video segment identified as title one—chapter two being displayed in a sub-window, and “BACK” and “NEXT” navigation buttons. In step 4141, the user pushes the “BACK” navigation button of the external user agent document Ext1.HTML 4201. Since the modified pointer to local user agent document Local5.HTML has been assigned to the “BACK” navigation button, in step 4161 the processor 104, under the control of the interaction application 202, user agent module 208, video playback module 204, and display control module 206, accesses and causes the display of local user agent document Local5.HTML.

Thus, by modifying the transmitted pointer identifying a path to the local user agent document and assigning the pointer to a navigation button of the external user agent document, disc navigation between the local and the external user agent documents can be made dynamically changed. The above method can be used to access multiple user agent documents from multiple servers across the Internet or an Intranet. Another advantage is that using most of the existing disc-based user agent content, developers can create a lively user experience by dynamically changing the navigation of the content even after the disc is shipped.

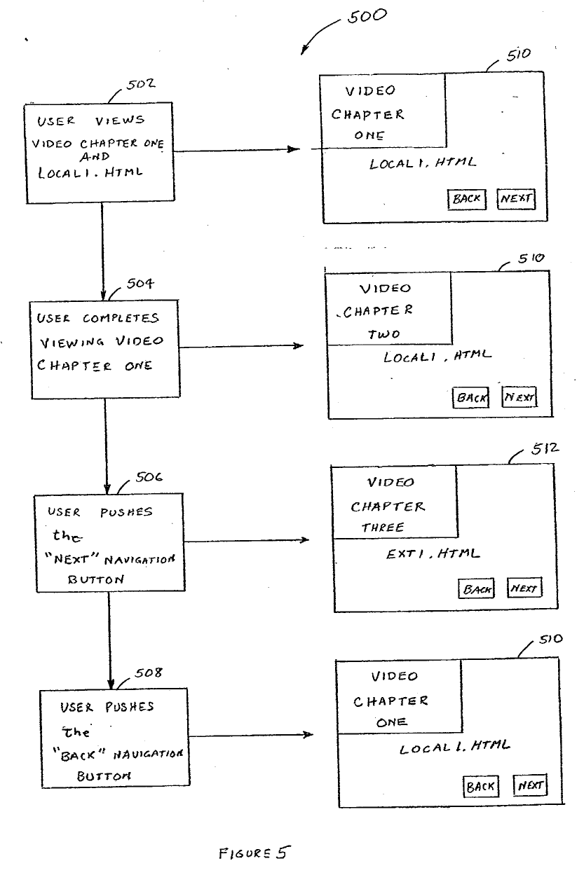

Another consideration when navigating between different user agent documents is the synchronization of the video to the user agent documents. Synchronization problems may occur if a user pushes a navigation button before completion of the video segment associated with the current user agent document. This can be explained with reference to FIG. 5.

FIG. 5 illustrates a flow diagram of a navigation method 500 which causes a de-synchronization of the video segment to the corresponding user agent document. In this case, two video segments chapter 1-2 are synchronized with a local user agent document Local1.HTML 510 and a video segment chapter 3 is synchronized with an external user agent document Ext1.HTML 512. In step 502, the user views user agent document Local1.HTML including video segment chapter 1. In step 504, the user completes viewing video segment chapter 1 and the optical disc player 100 (200) begins showing video segment chapter 2 on the Local1.HTML document 510. At this time, before the user sees the playback of video segment chapter 2, in step 506 the user pushes the “NEXT” navigation button on local user agent document Local1.HTML 510, which causes the optical disc player 100 (200) to send a request for the external user agent document Ext1.HTML 512 along with a pointer to the local user agent document Local1.HTML 510.

After the external user agent document Ext1.HTML 512 has been received and displayed by the optical disc player 100 (200), in step 508 the user pushes the “BACK” navigation button in the external user agent document Ext1.HTML 512. Since the pointer to the local user agent document Local1.HTML 510 is assigned to the “BACK” navigation button in the external user agent document Ext1.HTML 512, in step 508 the optical disc player 100 (200) accesses and displays the local user agent document Local1.HTML 510. However, when the local user agent document Local1.HTML 510 is accessed and displayed, the video segment chapter 1 may start playing again from the beginning. But, the user already has seen video segment chapter 1 as per step 502. Thus, to improve synchronization between the video and user agent documents when navigating between different user agent documents, there is a need to store the last playback location of the video segment when a navigation button has been activated.

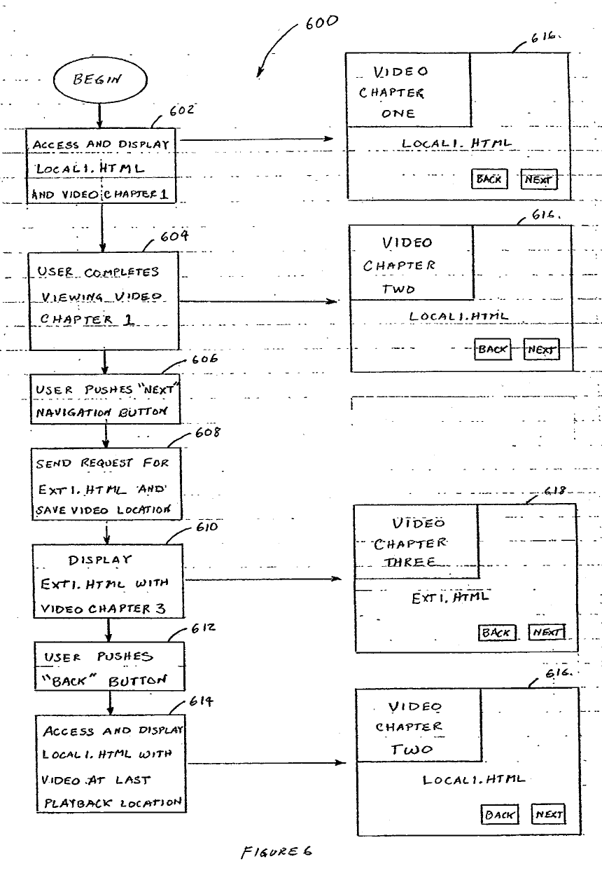

FIG. 6 illustrates a flow diagram of a navigation method 600 improves the synchronization of the video segment to the corresponding user agent document in accordance with the invention. In this case, two video segments chapter 1-2 are synchronized with a local user agent document Local1.HTML 616 and a video segment chapter 3 is synchronized with an external user agent document Ext1.HTML 618. In step 602, the optical disc player 100 (200) accesses and displays user agent document Local1.HTML including video segment chapter 1. In step 604, the user completes viewing video segment chapter 1 and the optical disc player 100 (200) begins showing video segment chapter 2 on the Local1.HTML document 616. At this time, before the user sees the playback of video segment chapter 2, in step 606 the user pushes the “NEXT” navigation button on local user agent document Local1.HTML 616, which causes the optical disc player 100 (200) to send a request for the external user agent document Ext1-HTML 618 along with a pointer to the local user agent document Local1.HTML 616. Also, in step 608, the optical disc player 100 (200) saves the video playback location (e.g. in a cookie) at the time the user pushed the “NEXT” navigation.

After the external user agent document Ext1.HTML 618 has been received and displayed by the optical disc player 100 (200) in step 610, in step 612 the user pushes the “BACK” navigation button in the external user agent document Ext1.HTML 618. Since the pointer to the local user agent document Local1.HTML 616 is assigned to the “BACK” navigation button in the external user agent document Ext1.HTML 618, in step 614 the optical disc player 100 (200) access and displays the local user agent document Local1.HTML 616. In this case, however, the optical disc player 100 (200) begins the video segment at the last video playback location saved in step 608. In this example, the last video playback location is the beginning of video segment chapter 2. Thus, the synchronization of the video to the user agent document has improved since the system returns to the video playback location at the time the user pushed the “NEXT” navigation button, thereby the user need not view what has already been previously shown

In the foregoing specification, the invention has been described with reference to specific embodiments thereof. It will, however, be evident that various modifications and changes maybe made thereto without departing from the broader spirit and scope of the invention The specification and drawings are, accordingly, to be regarded in an illustrative rather than a restrictive sense

It is claimed:

1. A method of navigating between a local user agent document and an external user agent document in an optical disc player, comprising:
accessing and displaying said local user agent document from a local optical disc;
transmitting a request for said external user agent document and a pointer to said local user agent document to an external source; and
receiving and displaying said external user agent document including a navigation button, wherein said pointer to said local user agent document is assigned to said navigation button.

2. The method of claim 1, wherein said external source comprises a server located on a network.

3. The method of claim 2, wherein said network comprises a wide area network.

4. The method of claim 2, wherein said network comprises a local area network.

5. The method of claim 1, wherein said external source comprises a hard disk drive.

6. The method of claim 1, wherein said external source comprises an external optical disc drive.

7. The method of claim 1, further comprising requesting approval to receive said external user agent document from said external source.

8. The method of claim 7, wherein requesting approval comprises transmitting a user identification number and/or password to said external source.

9. The method of claim 7, wherein requesting approval comprises transmitting an optical disc player identification number to said external source.

10. The method of claim 7, wherein requesting approval comprises transmitting a content-scrambling system (CSS) encryption information associated with said local optical disc to said external source.

11. The method of claim 7, wherein requesting approval comprises transmitting a burst coded area (BCA) number associated with said local optical disc to said external source.

12. The method of claim 7, wherein requesting approval comprises transmitting profile information related to a user and/or a group of users to said external source.

13. The method of claim 1, further comprising:
detecting an activation of said navigation button; and
accessing and displaying again said local user agent document using said pointer to said local user agent document.

14. An optical disc player, comprising:
an optical disc reader to read a local user agent document from a local optical disc;
an interface to an external source having an external user agent document; and
a processor to cause an access and a display of said local user agent document, to cause a transmission of a request for said external user agent document and a pointer to said local user agent document to said external source, and to receive and cause the display of said external user agent document including a navigation button, wherein said pointer to said local user agent document is assigned to said navigation button.

15. The optical disc player of claim 14, wherein said interface comprises a network interface.

16. The optical disc player of claim 14, wherein said interface comprises a Universal Serial Bus (USB) interface.

17. The optical disc player of claim 14, wherein said interface comprises a SCSI interface.

18. The optical disc player of claim 14, wherein said processor causes the transmission of said request and said pointer under a control of a user agent module.

19. The optical disc player of claim 14, wherein said processor receives a signal indicating said navigation button has been activated, and causes a re-access and re-display of said local user agent document in response to said signal.

20. The optical disc player of claim 14, further comprising a display for displaying said local and external user agent documents.

21. The optical disc player of claim 14, wherein said processor causes a playback of video data within said local user agent document and/or said external user agent document under a control of a video playback module.

22. A method of synchronizing video with user agent documents, comprising:
accessing and displaying a first user agent document including a playback of a first video segment within said first user agent document;
receiving a first request for a second user agent document while the playback of said first video segment is at a particular video playback location;
accessing and displaying said second user agent document;
receiving a second request for said first user agent document; and
re-accessing and re-displaying said first user agent document including a playback of said first video segment starting at approximately said particular video playback location.

23. The method of claim 22, wherein said first user agent document comprises a local user agent document accessed from a local optical disc.

24. The method of claim 22, wherein said second user agent document comprises an external user agent document accessed from an external source.

25. The method of claim 22, wherein receiving said first and/or said second requests is received by way of an activation of a navigation button.

26. The method of claim 22, further comprising storing information related to said particular video playback location.

27. The method of claim 26, further comprising retrieving said information to said particular video playback location in order to playback said first video segment starting at approximately said particular video playback location.

28. An optical disc player, comprising a processor to cause a display of a first user agent document and a playing back of a first video segment within said first user agent document, to cause a display of a second user agent upon receiving a first request for said second user agent document while the playback of said first video segment is at a particular video playback location, and to cause a re-display of said first user agent document and a playing back of said first video segment starting at approximately said particular video playback location upon receiving a second request for said first user agent document.

29. The optical disc player of claim 28, further comprising an optical disc reader to access said first and/or second user agent documents from a local optical disc.

30. The optical disc player of claim 28, further comprising an external source interface to access said first and/or second user agent documents from an external source.

31. The optical disc player of claim 28, further comprising a display for displaying said first and second user agent documents.

32. The optical disc player of claim 28, further comprising an input device to receive from a user said first and/or second requests.

33. A method of navigating between a local user agent document and an external user agent document in an optical disc player, comprising:
accessing and displaying said local user agent document from a local optical disc;
transmitting a request for said external user agent document to an external source; and
receiving and displaying said external user agent document including a navigation button, wherein a pointer to another user agent document is assigned to said navigation button.

34. An optical disc player, comprising:
an optical disc reader to read a local user agent document from a local optical disc;
an interface to an external source having an external user agent document; and
a processor to cause an access and a display of said local user agent document, to cause a transmission of a request for said external user agent document to said external source, and to receive and cause the display of said external user agent document including a navigation button, wherein a pointer to another user agent document is assigned to said navigation button.
